(19) United States
(12) Patent Application Publication
(10) Pub. No.: US 2006/0115612 A1
(43) Pub. Date: Jun. 1, 2006

(54) Ink-jet recording sheets

(75) Inventors: Masahiro Nakata, Tokyo (JP); Akane Okawa, Tokyo (JP); Kozo Tajiri, Tokyo (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: OJI PAPER CO., LTD., Tokyo (JP)

(21) Appl. No.: 11/291,171

(22) Filed: Dec. 1, 2005

Related U.S. Application Data
(63) Continuation of application No. PCT/JP03/07026, filed on Jun. 3, 2003.

(51) Int. Cl. B41M 5/00

(52) U.S. Cl. 428/32.34

(57) ABSTRACT

The present invention discloses an ink-jet recording sheet which, on at least one surface of a support, has a porous ink absorbing layer containing fine particle silica having the average particle size of 0.5 μm or smaller produced by wet process, electrolytes such as alkaline metal salts and alkaline earth metal salts, and polyvinyl alcohol; and then has a gloss layer. The ink-jet recording sheet has excellent features, that is, it has gloss like that of photographic printing paper, the excellent ink absorption speed and ink absorption capacity, and does not produce defects of the coating due to the cracks generated during drying in production processes of the ink absorbing layer. Therefore, the ink-jet recording sheet is suitable as a recording sheet for an ink-jet printer.

### BACKGROUND OF THE INVENTION

The present invention relates to ink-jet recording sheets, and especially those having gloss like that of photographic printing paper, combining high ink absorption speed with large ink absorption capacity, and without cracks in an ink absorbing layer.

Ink-jet recording is a recording method which is suitable as personal use since color printing can be conducted inexpensively by a simple apparatus, and it is rapidly spreading at the office and at home for printing use. Recent years, its image quality is rapidly being improved because of achievement of full-colorization and high resolution, and, therefore, it is paid attention to as an easy output form of color images and thought to be one of the most influential methods as an alternative to silver salt photos. Thus, ink-jet recording sheets have been desired such as those having high gloss and high image quality equal to those of the silver salt photos.

Since ink which is used in ink-jet method contains a large amount of a solvent(s), a large amount of ink have to be discharged in order to obtain high density of printing. Therefore, materials are required such as those that can fully absorb discharged ink as an ink absorbing layer which is provided on ink-jet recording sheets. Further, as ink droplets are discharged continuously, when a next droplet is discharged before a first droplet is absorbed, it causes bleeding or uneven density, and, therefore, vivid images cannot be obtained. Accordingly, the ink absorbing layer is required to have fast absorption speed as well as the large absorption capacity. Further, in addition to the above requirements for the image quality, various performances are also required such as drying property of ink, water resistance of printed matters, preservation stability of the images in case of long-term storage.

In order to fulfill the above requirements, a lot of ink-jet recording sheets which have a resin or pigment ink absorbing layer are suggested and marketed. The resin absorbing layer(s) is usually formed by coating an aqueous solution(s) of a water-soluble resin(s) such as polyvinyl alcohol, polyvinyl pyrrolidone, water-soluble cellulose derivatives, and gelatin to a support and then being dried. The resin absorbing layer(s) has advantage that it has high (optical) print density and high gloss because of its high transparency. On the other side, it has defects that the image quality is not good because its ink absorption speed is slow, and the water resistance is not good either because its ink drying speed is also slow. Therefore, it is difficult for the resin absorbing layer(s) to obtain equivalent print quality to that of the silver salt photos, which is a required quality in recent years. Thus, the following pigment absorbing layer(s) has been the mainstream, recently.

The pigment absorbing layer(s) is formed by adding, as a binder resin, a water-soluble resin(s) such as polyvinyl alcohol and cellulose derivatives to pigments such as silica, alumina, p-Boehmite, calcium carbonate and kaolin. As for the form of the above pigments, it is preferably used that primary particles aggregate to form secondary particles. In those pigment absorbing layers, their image quality is high and ink drying speed is also fast because ink is rapidly absorbed in voids between the primary particles and the secondary particles by capillary phenomenon to form images.

The secondary particles of many of commercially available pigments are usually over 1 μm. When such pigments are used as the pigment absorbing layer(s), ink absorbability is high because large voids between the secondary particles are formed. However, smoothness of the surface of the absorbing layer is low and its gloss is also low since the diameters of the secondary particles are large. Accordingly, such absorbing layer(s) is not suitable for the object to obtain high gloss like that of photographic printing paper, which is a required object in recent years. Further, it has defects that the print density is low because of its low transparency. For example, as suggested in Japanese Patent Unexamined Publication No. Sho 61-47290, the ink absorbing layer containing mild acid salts of alkaline metals and/or double salts thereof has a combination of ink absorbability with water and light resistance of images by using the mild acid salts of alkaline metals in combination with a pigment(s) having average secondary particle sizes of 0.5 to 30 μm. However, its gloss and print density are low since the pigment(s) has to be used, such as those having a large secondary particle size.

In order to overcome the above defects, a lot of ink-jet recording sheets are suggested, which have a pigment ink-jet absorbing layer(s) wherein fine particle pigments having a particle size of 1 μm or smaller are used. In Japanese Unexamined Publication No. Hei 9-183267, an ink absorbing layer was suggested such as that containing colloidal silica in its top layer and having the peak of the pore distribution curve in the range of a pore diameter of 2 nm to 100 nm. When the pore peak existed within this range, the ink absorption speed became faster. Further, the ink absorbing layer had excellent gloss and high transparency since monodisperse colloidal silica of which particle size was small was used. However, a particle volume of the absorbing layer(s) was low because colloidal silica did not form the secondary particles, and, therefore, the layer(s) had a defect that a large quantity of coating was needed in order to make the layer(s) absorb a large quantity of discharged ink. In Examples of Japanese Unexamined Publication No. Hei 9-183267, an example that two peaks appeared within the above range is described. However, those two peaks mean that, when two ink absorbing layers were provided, one peak at a time which existed in each of the absorbing layers appeared. Further, it is not described that electrolytes are included in the ink absorbing layers.

Japanese Unexamined Publication No. 2001-96897 suggests ink-jet recording materials having an ink absorbing layer of which surface pH is 3 to 5 and contains gas-phase-method silica and water-soluble metal compounds. The gas-phase-method silica is ultrafine particles wherein the primary particles of the average particle size of 3 nm to 10 nm aggregate to form the secondary particles. As its particle size is small, it can generate high gloss. Ink absorbability is also high because there are voids between the secondary particles. On the other hand, when ultrafine particles of the secondary particle size of 1 μm or smaller are used, pore diameter is smaller because of the small particle size, and it causes a defect in manufacturing that an ink absorbing layer tend to be cracked in drying process because of the strong contractile force due to the capillary force. It is not preferable to increase addition of a binder resin(s) in order to reduce the contractile force due to the capillary force and prevent cracking because it causes extreme decrease in ink absorbability. In the above publication, though addition of water-soluble metal compounds is suggested, surface pH needs to be adjusted to 3 to 5. Further, the gas-phase-method silica has a dramatically stronger contractile force due to the capillary force generated in the drying process compared with wet-process silica. Therefore, in order to produce an absorbing layer(s) with no cracking in acceptable degree, the method has to be used such as that wherein a binder resin(s) is cross-linked by boric acid in addition to the above method. Thus formed absorbing layer(s) had defects that its strength becomes fragile under high temperature and high humidity and it removes.

### DISCLOSURE OF THE INVENTION

An object of the present invention is to solve the problems which the above prior arts are facing and to provide a recording sheet for an ink-jet printer which has gloss like that of photographic printing paper, the excellent ink absorption speed and ink absorption capacity, and does not produce defects of the coating due to the cracks generated during drying in production processes of an ink absorbing layer.

In the pore distribution curve obtained by measurement with a mercury porosimetry, a porous ink absorbing layer having the peak in the range of a pore diameter of 6 nm to 150 nm can usually obtain vivid images by rapidly absorbing ink due to the strong capillary force. However, it is often the case that the porous ink absorbing layer which has the pore diameter within the above range and has only one narrow and sharp peak as shown in FIG. 2 produces defects of the coating due to the cracks by the strong contractile force due to the capillary force in drying process after coating with a coating solution(s) of an ink absorbing layer. In addition, it is also often the case that the ink absorption capacity is not sufficient enough to instantly absorb a large quantity of discharged ink and, therefore, ink sometimes overflows or uneven print density known as beading tends to occur.

The inventors have thoroughly studied the above problems to be solved and found that a porous ink absorbing layer which has two peaks or one wide peak having shoulders in the range of a pore diameter of 6 nm to 150 nm as shown in FIG. 1 does not crack in drying process; its ink absorption speed is fast; and the ink absorption capacity increases. They have further studied on methods for forming the above porous ink absorbing layer which has such pore distributions and found that such a layer can be formed by using electrolytes in addition to fine particle silica produced by wet process and polyvinyl alcohol. Though the porous ink absorbing layer does not have sufficient gloss as it stands since the layer has large pores, high gloss, excellent recording density and appearance like silver salt photos can be obtained by equipping a gloss layer on the above layer. The present invention has been completed on the basis of this finding.

The present invention includes the following embodiments.

[1] An ink-jet recording sheet which, on at least one surface of a support, has a porous ink absorbing layer containing fine particle silica having the average particle size of 0.5 μm or less produced by wet process, electrolytes, and polyvinyl alcohol; and then has a gloss layer.

[2] The ink-jet recording sheet according to [1], wherein 75 degree C. specular gloss (JIS P8142) is 40% or more.

[3] The ink-jet recording sheet according to [1] or [2], wherein the support is a gas impermeable support.

[4] The ink-jet recording sheet according to [3], wherein 75 degree C. specular gloss (JIS P8142) of the gas impermeable support is 60% or more.

[5] The ink-jet recording sheet according to any one of [1] to [4], wherein the fine particle silica is secondary particles having the average particle size of 8 nm to 500 nm and preferably 20 nm to 300 nm which are formed by aggregation of primary particles having the average particle size of 3 nm to 100 nm and preferably 3 nm to 40 nm.

[6] The ink-jet recording sheet according to any one of [1] to [5], wherein specific surface area and pore volume of the fine particle silica measured with nitrogen adsorption method meet the following formula 1.
Specific surface area (m²/g)<730−600×Pore volume (ml/g) (Formula 1)
[7] The ink-jet recording sheet according to [6], wherein the specific surface area and the pore volume of the fine particle silica measured with nitrogen adsorption method meet the following formula 2.
Specific surface area (m²/g)>450−600×Pore volume (ml/g) (Formula 2)
[8] The ink-jet recording sheet according to [7], wherein the specific surface area of the fine particle silica is 150 to 300 m²/g and the pore volume thereof is 0.5 to 0.9 ml/g.
[9] The ink-jet recording sheet according to any one of [1] to [8], wherein the fine particle silica is produced by the polycondensation of active silicic acid(s).
[10] The ink-jet recording sheet according to any one of [1] to [9], wherein the electrolytes are at least one kind of compounds selected from the group consisting of alkaline metal salts and alkaline earth metal salts.
[11] The ink-jet recording sheet according to [10], wherein the electrolytes are salts of strong acids of alkaline metals.
[12] The ink-jet recording sheet according to any one of [1] to [11], wherein the ratio of the electrolyte content is 0.05 to 5 parts relative to 100 parts of the fine particle pigments.
[13] The ink-jet recording sheet according to any one of [1] to [12], wherein the degree of saponification of polyvinyl alcohol is 90% or more.
[14] The ink-jet recording sheet according to any one of [1] to [13], wherein the degree of polymerization of polyvinyl alcohol is 1700 or more.
[15] The ink-jet recording sheet according to any one of [1] to [14], wherein the porous ink absorbing layer has two peaks or one wide peak having shoulders in the range of a pore diameter of 6 nm to 150 nm in a pore distribution curve measured by a mercury porosimetry.
[16] The ink-jet recording sheet according to [15], wherein an absolute value of difference between a mode pore diameter and median pore diameter in the pore distribution curve is 10 nm or more.
[17] The ink-jet recording sheet according to [15] or [16], wherein the pore volume of the porous ink absorbing layer in the range of pore diameter from 6 nm to 1 μm is 0.5 to 2.0 ml/g.
[18] The ink-jet recording sheet according to any one of [1] to [17], wherein surface pH of the porous ink absorbing layer is 5 to 10.
[19] The ink-jet recording sheet according to any one of [1] to [18], comprising the steps of coating a support with a water-based coating liquid(s) of pH 7 or more containing the fine particle silica, the electrolytes and polyvinyl alcohol; and then drying it to form the porous ink absorbing layer.

### BRIEF DESCRIPTION OF THE DRAWINGS

FIG. 1 is a graphic view indicating a pore distribution curve of a porous ink absorbing layer in the present invention. V indicates the pore volume of the ink absorbing layer, and D indicates a pore diameter thereof.

FIG. 2 is a graphic view (not the present invention) indicating a pore distribution curve of an ink absorbing layer wherein electrolytes are not contained and there is only one peak in the range of a pore diameter of 6 nm to 150 nm.

FIG. 3 is a graphic view wherein the specific surface area of silica is set to the vertical axis of the graph and the pore volume thereof is set to the horizontal axis of the graph; and Haze values of coating in case of coating base materials with each silica as a coating(s) are classified into five phases and described.

Haze values were determined in accordance with JIS standards K7105 by using a coating wherein 20 parts of Polyvinyl Alcohol 140H manufactured by Kuraray Co., Ltd. was added to silica; coating a base material manufactured by Toray Industries, Inc., trade name: Lumirror 100-Q80D, with the coating so that dry mass is 20 g/m²

### BEST MODE FOR CARRYING OUT THE INVENTION

Methods for forming the porous ink absorbing layer of the present invention are herein described. The porous ink absorbing layer of the present invention is produced by solidifying wet-process fine particle silica having the average particle size of 0.5 μm or smaller with polyvinyl alcohol. Though the methods for forming it are not particularly limited, the following method is suitably used in order to obtain the porous ink absorbing layer having the excellent ink absorption speed and ink absorption capacity, and without producing defects of the coating due to the cracks generated during drying in production processes. The ink absorbing layer is formed by coating a support with a water-based coating liquid(s) containing 1 to 100 parts by weight of polyvinyl alcohol, preferably 3 to 28 parts by weight thereof, and more preferably 5 to 20 parts by weight thereof to 100 parts by weight of fine particle silica; and preferably 0.01 to 10 parts by weight of electrolytes and more preferably 0.05 to 5 parts by weight thereof; and being dried.

The fine particle silica used in the present invention has a particle size of 0.5 μm or smaller, and stably disperses in a colloid in the above water-based coating liquid(s). In drying process, by the time when the density of the water-based coating liquid(s) increases and the coating(s) is dried, the contained electrolytes are adsorbed to the surface of the fine particle silica to make the charge quantity of the surface decrease. Thus, dispersion stability is lost and a large aggregation structure is generated by effects of polyvinyl alcohol. The voids which exist in the aggregation structure are distributed in the range of 6 nm to 150 nm and, as a result, the porous ink absorbing layer having two peaks or one wide range of peak having shoulders in the range of a pore diameter of 6 nm to 150 nm is formed. Thus, the aggregation structure is generated by the effect of the electrolytes, and the contractile force due to the capillary force is alleviated by the existence of many pores having a large diameter to prevent cracking in drying process after coating the ink absorbing layer.

Silica used in the present invention is the silica which is chemically synthesized by wet process. Silica is classified broadly into a natural silica which is obtained by crushing natural silica such as quartz and synthetic silica which is produced by synthesis. The synthetic silica is further classified broadly into wet-process silica and dry-process silica. As the wet-process silica, silica produced by precipitation method and silica produced by gel method are known, and silica produced by the polycondensation of active silicic acid is also included thereto as mentioned afterward. The silica by precipitation method is produced by, for example, adding a mineral acid(s) stepwise to an alkaline aqueous solution of silicic acid; and filtering precipitated silica as disclosed in Japanese Patent Unexamined Publication No. Sho 55-116613. The silica by gel method is obtained by mixing a mineral acid(s) with an alkaline solution of silicic acid and conducting gelation; and then washing and crushing the substance. In the silica by precipitation method and the silica by gel method, the primary particles of the silica bond to form the secondary particles and, therefore, many voids exist between the primary particles and the secondary particles. Accordingly, the silica is preferably used in the present invention due to their high print density because their ink absorption capacity is large and their property to scatter light is low.

Dry-process silica is also known as gas-phase method silica. For example, as disclosed in Japanese Patent Unexamined Publication No. Sho 59-169922, the silica is produced by disintegrating volatile silicon compounds in high temperature in flame. It is commercially available as powder whose bulk density is very low. When water dispersions of the dry-process silica are dried, it becomes porous silica gel. The pore volume of the gel by nitrogen adsorption method is 1.2 to 1.6 ml/g. Though it is convenient for absorbing ink, it is difficult to produce an ink absorbing layer without cracks since cracks are significant when dried. Further, even if polyvinyl alcohol and electrolytes are added thereto and the ink absorbing layer is produced, the aggregation structure is not generated. In this regard, silica produced by wet process is superior to dry-process silica.

As a somewhat specific production method of wet-process silica, it is known that an active silicic acid is condensed to produce the silica. For instance, the method for making particles of colloidal silica grow is disclosed in the specification of U.S. Pat. No. 2,574,902, comprising steps of: treating a diluted aqueous solution of sodium silicate with a cation-exchange resin(s) to prepare an aqueous solution of an active silicic acid by removing sodium ions; adding alkalis to a part of the aqueous solution of the active silicic acid(s) and polymerizing by stabilization to prepare a solution wherein seed particles of silica disperse (seed solution); and gradually adding a rest of the aqueous solution of the active silicic acid (feed solution) thereto with keeping alkali condition and polymerizing to make the particles of colloidal silica grow. The silica produced by this method has a diameter of 3 nm to several hundreds nm, does not form the secondary aggregation and has a feature that the particle size distribution is extremely narrow. It is usually known as colloidal silica, and those having a diameter of 7 nm to 100 nm are commercially available as water dispersions. When they are used in an ink absorbing layer, an absorbing layer(s) having extremely high gloss and high transparency can be obtained. However, since they are not secondary particles, the silica by precipitation method or the silica by gel method is superior to them in terms of the ink absorption capacity.

It is also possible to produce silica which combines the advantages of silica by precipitation method and by gel method with those of colloidal silica by the polycondensation of the active silicic acid. Concrete examples are silica which is disclosed in Japanese Patent Unexamined Publication Nos. Hei 2001-354408 and Hei 2002-145609. The silica is secondary particles wherein primary particles of silica bond, and it is easy to adjust a diameter of the secondary particles to wavelength of light or less. Since it is easy to produce an ink absorbing layer which has high ink absorption capacity and high gloss, the silica is most preferably used in the present invention.

In Japanese Patent Unexamined Publication No. Hei 2001-354408, the following production methods are described:

“A method for producing a silica fine particle dispersion liquid wherein silica fine particles having the specific surface area of 100 to 400 m²/g by the nitrogen adsorption method, average secondary particle size of 20 to 30 nm and the pore volume of 0.5 to 2.0 ml/g disperse in a colloidal state, comprising steps of: adding alkalis to a seed solution wherein silica fine particles having the specific surface area of 300 to 1000 m²/g by the nitrogen adsorption method and the pore volume of 0.4 to 2.0 ml/g disperse in a colloidal state; and gradually adding a feed solution consisting of at least one kind selected from an aqueous solution of an active silicic acid and an alkoxysilane to the seed solution to grow the silica fine particles.”

“A method for producing a silica fine particle dispersion liquid wherein silica fine particles having the specific surface area of 100 to 400 m²/g by the nitrogen adsorption method, average secondary particle size of 20 to 30 nm and the pore volume of 0.5 to 2.0 ml/g disperse in a colloidal state, comprising steps of: adding by portions a mixture of alkalis and a feed solution consisting of at least one kind selected from an aqueous solution of an active silicic acid and an alkoxysilane to a seed solution wherein silica fine particles having the specific surface area of 300 to 1000 m²/g by the nitrogen adsorption method and the pore volume of 0.4 to 2.0 ml/g disperse in a colloidal state; or adding by portions the feed solution and alkalis simultaneously to the seed solution to grow the silica fine particles.”

In Japanese Patent Unexamined Publication No. Hei 2002-145609, the following production method is described:

“A method for producing a silica fine particle dispersion liquid, comprising steps of heating an aqueous solution containing at least one compound selected from an active silicic acid and alkoxysilanes to form a suspension containing agglomerates each consisting of fine silica particles; adding an aqueous solution containing the active silicic acid and/or an alkoxysilane by portions to the suspension in the presence of alkalis to grow fine silica particles in the suspension; and thereafter, subjecting the suspension to wet pulverization.”

As fine particle silica, their average particle size must be 0.5 μm or smaller in order to obtain an ink absorbing layer having high gloss and high transparency. The fine particle silica preferably has the average primary particle size of 3 nm to 100 nm and it is more preferably the secondary particles consisting of the primary particles of 3 nm to 4 nm since the pore volume is high. The average particle size of the secondary particles wherein the primary particles aggregate is 0.5 μm or smaller, preferably 8 nm to 499 nm, more preferably 10 nm to 400 nm and most preferably 20 nm or more and less than 300 nm. When the primary and secondary particle sizes are too small, the voids which contribute to ink absorption are not easily formed. As a result, there is a risk of decrease in ink absorbability because of decrease in the pore volume of the absorbing layer(s). When the primary and secondary particle sizes are too large, it causes decrease in transparency of the absorbing layer(s), and there is a risk of deterioration of print density and gloss. Meanwhile, all of the primary particle sizes mentioned in the present invention are particle sizes (Martin's diameter) observed by an electronic microscope (SEM and TEM). The secondary particle sizes are determined by dynamic light scattering method and their values are calculated from analysis using the Cumulant method.

It is preferable that the specific surface area and the pore volume of the fine particle silica measured with nitrogen adsorption method meet the following formula 1.
Specific surface area (m²/g)<730−600×Pore volume (ml/g) (Formula 1)

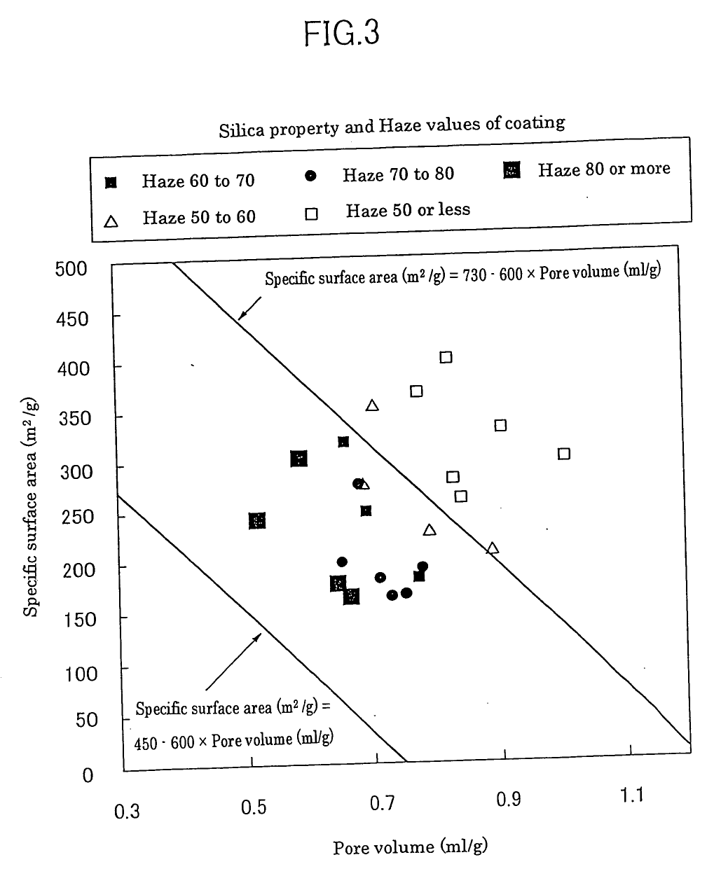

The inventors produced fine particle silica having various specific surface areas and pore volumes based on Japanese Patent Unexamined Publication No. Hei 2001-354408, added polyvinyl alcohol thereto as a binder and prepared ink absorbing layers with the silica coated on them. As a result, they found that, as shown in FIG. 3, the silica were clearly divided into the area in which transparency of the ink absorbing layer is high, that is, Haze value is low; and the area in which its transparency is low, that is, Haze value is high. The formula which indicates the borderline between two areas was Specific surface area (m²/g)<730−600×Pore volume (ml/g). High Haze value means that voids of a large pore size generate in large quantity. When the silica is used in an ink absorbing layer, silica which meets the formula 1 is promoted to aggregate by addition of a small amount of electrolytes, that is, 0.05 to 1 part by weight thereof to 100 parts by weight of silica. Cracks of the ink absorbing layer were prevented and ink absorbability was high.

However, as silica wherein the specific surface area and the pore volume of the fine particle silica meet the formula 3 is slightly inferior in ink absorbability, it is more preferable that they meet the formulae 1 and 2 simultaneously.
Specific surface area (m²/g)>450−600×Pore volume (ml/g) (Formula 2)
Specific surface area (m²/g)<450−600×Pore volume (ml/g) (Formula 3)

It is further preferable that the fine particle silica meets the formulae 1 and 2 simultaneously, the specific surface area is 150 to 300 m²/g, and the pore volume is 0.5 to 0.9 ml/g. The silica within this range has excellent balance of prevention of cracks of the ink absorbing layer, ink absorbability and gloss.

The methods for preparing fine particle silica having the average particle size of 0.5 μm or smaller from silica are not particularly limited. One of the methods is that a strong force is given to commercially available silica (particle size is several μm to several dozen μm) with mechanical means and cracks and disperse the silica to obtain the fine particle silica. Namely, it is obtained by the breaking down method (the method for segmentalizing aggregated raw materials). As the mechanical means, they include an ultrasonic homogenizer, a pressure type homogenizer, a nanomizer, a high-speed tumbling mill, a roller mill, a bowl-drive-medium mill, a medium-stirring mill, a jet mill, and a sand grinder. The obtained fine particle silica may be in colloidal state or slurry state.

The method of condensation of the active silicic acid, which is disclosed in Japanese Patent Unexamined Publication No. Hei 2001-354408, can be preferably used in the present invention because the fine particle silica having the above particle size and pore volume can be directly produced without using mechanical means, and transparency and gloss of the ink absorbing layer are high because of the narrow particle size distribution. Here, the active silicic acid indicates an aqueous solution of a silicic acid of pH 4 or less which can be obtained by taking ion-exchange treatment to an aqueous solution of alkali metal silicate with a hydrogenous cation-exchange resin. The concentration of SiO₂ is preferably 1 to 6 weight %. It is more preferable that the aqueous solution of the active silicic acid is 2 to 5 weight % and pH 2 to 4. As for alkali metal silicates, they may be commercially available industrial products. It is more preferable that sodium water glass is used, whose molar ratio of SiO₂/M₂O (M represents an alkali metal atom(s)) is about 2 to 4.

The condensation method of the active silicic acid is preferably comprising steps of: generating seed particles by adding the above aqueous solution of the active silicic acid dropwise to hot water or by heating the aqueous solution of the active silicic acid; stabilizing the seed particles by adding alkalis thereto before the dispersion liquid precipitates or gelates; and adding the aqueous solution of the active silicic acid thereto with keeping the stable state, in the speed of preferably 0.001 to 0.2 mmol/min. in SiO₂ to 1 mmol of SiO₂ contained in the seed particles to grow the primary particles of the seed particles.

The electrolytes which are used may be inorganic acids, inorganic bases, salts, organic acids, or organic bases. Strong electrolytes are preferably used because the addition amount may be smaller. It is also preferable that solubility in 100 g of water is 0.01 g or more at 25° C.

Preferable examples of the electrolytes are alkaline metal salts such as sodium sulfate, sodium chloride, sodium hydrogensulfate, sodium nitrate, sodium acetate, sodium formate, sodium carbonate, sodium hydrogencarbonate, sodium dihydrogen phosphate, disodium hydrogen phosphate, trisodium phosphate, sodium thiosulfate, potassium sulfate, potassium chloride, potassium hydrogensulfate, potassium nitrate, potassium acetate, potassium formate, potassium carbonate, potassium hydrogencarbonate, potassium dihydrogen phosphate, dipotassium hydrogen phosphate, tripotassium phosphate, and potassium thiosulfate; alkaline earth metal salts such as calcium sulfate, calcium chloride, calcium nitrae, calcium acetate, calcium formate, calcium carbonate, calcium hydrogen phosphate, calcium dihydrogen phosphate, tricalcium phosphate, barium sulfate, barium chloride, barium nitrate, barium acetate, barium formate, barium carbonate, barium hydrogen phosphate, barium dihydrogen phosphate, tribarium phosphate, magnesium sulfate, magnesium chloride, magnesium nitrate, magnesium acetate, and magnesium carbonate; water-soluble salts such as manganese chloride, manganese acetate, manganese formate, cupric chloride, copper sulfate, cobalt chloride, nickel sulfate, nickel chloride, aluminum sulfate, aluminum sulfite, aluminum thiosulfate, poly aluminum chloride, aluminum nitrate, aluminum chloride, ferrous bromide, ferrous chloride, ferric chloride, ferrous sulfate, ferric sulfate, zinc bromide, zinc chloride, zinc nitrate and zinc sulfate; and lithium hydroxide, sodium hydroxide, potassium hydroxide, calcium hydroxide, strontium hydroxide, and barium hydroxide, though they are not limited to these examples. The electrolytes can be used not only by its own but also by mixing two kinds or more thereof.

Among the above, alkaline metal salts and alkaline earth metal salts are suitably used because they can be easily mixed to water-based coating liquids and easily aggregate pigments in drying process after coating the water-based coating liquids, and, therefore, the porous ink absorbing layer of the present invention can be easily obtained from them. Further, strong acid salts of the alkaline metals and the alkaline earth metals, that is, hydrochloride, sulfate, nitrate and phosphate and the like are most suitably used because they can exist most stably in the water-based coating liquids and do not precipitate under alkaline condition. Their examples include sodium sulfate, sodium chloride, sodium nitrate, potassium sulfate, potassium chloride, potassium nitrate, calcium chloride, calcium sulfate and calcium nitrate. Among them, hydrochloride, sulfate and nitrate of alkaline metals are preferable.

Though weak acid salts of alkaline metals are used in Japanese Patent Unexamined Publication No. Sho 61-47290, it is different from the present invention in that it is limited to the weak acid salts and that the secondary particle size of the pigments used therein is larger, e.g., 0.5 to 30 μm. In the present invention, the electrolytes of water-soluble salts and the like are used for agglomerating particles in the drying process and preventing cracks, and they are not particularly limited to the weak acid salts of alkaline metals.

Though gas-phase-method silica and water-soluble metal compounds are used in Japanese Patent Unexamined Publication No. 2001-96897, it is different from the present invention in that the used pigments are gas-phase-method silica and that surface pH is in the acidic region, e.g., 3 to 5. The present invention is different from Japanese Patent Unexamined Publication No. 2001-96897 wherein polyvalent metal salts are used, in that the fine particle silica by wet process is used together with the electrolytes and that alkaline metal salts are preferably used as the electrolytes in the present invention. The present invention is also different from Japanese Patent Unexamined Publication No. 2001-96897 in that the surface pH of the porous ink absorbing layer is preferably 5 or more in the present invention. The surface pH of the porous ink absorbing layer in the present invention is not particularly limited. However, it is preferably 5 or more, and its upper limit is, though it is not limited, around 10. It is preferable to keep the surface pH 5 or more because cracks do not easily occur.

A used binder resin is polyvinyl alcohol. Even if a binder resin(s) other than polyvinyl alcohol is used, it is not usable because an ink absorbing layer is cracked and ink absorbability is not good. Though it is not clear why polyvinyl alcohol is usable, it would appear that polyvinyl alcohol moderately interacts with silica and agglomerate them by its multiplier effect with the electrolytes.

The degree of saponification of polyvinyl alcohol is particularly preferably 90% or more and most preferably 95% or more. Higher the degree of saponification is, less the cracks of the ink absorbing layer are. Besides it, the absorbability is also high. The reason would appear that highly saponified polyvinyl alcohol (PVA) containing a number of hydroxyl groups interacts with silica more strongly and promotes their aggregation. Further, the degree of polymerization of polyvinyl alcohol is preferably 1700 or more, more preferably 2500 or more and most preferably 3500 or more. Its upper limit is, though it is not particularly limited, around 10000. Higher the degree of polymerization is, less the cracks of the ink absorbing layer are.

In the present invention, pH of water-based coating liquids is not particularly limited. However, it promotes generation of a large aggregation structure in drying process to control their pH to 7 or more and preferably 8 or more. Therefore, such controlled water-based coating liquids are suitably used to obtain the ink absorbing layer of the present invention. The upper limit of pH is, though it is not particularly limited, around 10, for instance. The methods for controlling pH are not particularly limited, but the method for adding ammonia, sodium hydroxide and potassium hydroxide to the water-based coating liquids is easy and convenient and effective to be suitably used.

In addition to the fine particle silica, polyvinyl alcohol and the electrolytes, various additives are used in accordance with the purposes. For example, they include cationic resins as an ink fixing agent. The examples of the cationic resins are resins containing a cationic structural unit(s) such as quaternized N,N-dimethylaminoethyl acrylate, quaternized N,N-dimethylaminoethyl methacrylate, quaternized N,N-dimethylaminopropyl acrylamide, vinylimidazolium methochloride, diallyldimethylammonium chloride, methyldiallylamine, diallylamine, monoallylamine and amidine ring. When the cationic resins are added by mixing them with dispersion liquid of anionic pigments such as silica, the coatings temporarily gelate because of the electrostatic property of both sides, but they become usable by dispersing them again using mechanical means such as homogenizers. In addition, it is possible to dispense, for example, aluminasol as cationic materials. However, since addition of the cationic resins tends to deteriorate the cracks of the ink absorbing layer, it is preferable that the addition is conducted after forming the ink absorbing layer and that the resins are absorbed into the ink absorbing layer by coating or impregnating an aqueous solution of the cationic resins.

Other additives are accordingly added thereto, for example, auxiliary agents used for production of usual enamel paper such as dispersants, thickeners, antifoamers, colorants, antistatic agents, and wetting agents; and ultraviolet absorbers and light stabilizing agents for improving conservation of print images.

The supports of the present invention are not particularly limited, but it is preferable to use paper or film which are gas impermeable supports, for example, synthetic-resin film such as polyethylene terephthalate, polyvinyl chloride, polycarbonate, polyimide, cellulose triacetate, cellulose diacetate, polyethylene, and polypropylene; or synthetic-resin laminated paper such as polyethylene laminated paper because it is easy to obtain high gloss ink-jet recording sheets. 75 degree C. specular gloss of the gas impermeable supports is preferably 60% or more, more preferably 80% or more and most preferably 100% or more. Meanwhile, 75 degree C. specular gloss of the present invention was determined in accordance with JIS standards P8142.

These supports can be given an undercoating layer or treated with various treatments such as corona discharge treatment to make them easily adhere in case that the supports do not sufficiently adhere to the ink absorbing layer formed on their surface. The thickness of the supports is preferably 50 to 500 μm, considering paper feed ability of a printer(s).

As for the coating methods of the water-based coating liquids of the present invention, publicly known coating methods can be used, such as bar-coating, roller coating, blade coating, airknife coating, gravure coating, dye coating, and curtain coating; but not limited to these.

The coating amount of the ink absorbing layer is preferably about 1 to 50 g/m² as mass after drying, and further preferably 3 to 25 g/m². Here, when the amount is less than 1 g/m², there is a risk of insufficient ink absorption, and when it is more than 50 g/m², there is a risk of curling and expenses pile up.

Next, herein describe is pore distribution measurement with a mercury porosimetry. The pore distribution was calculated from the void volume distribution curve obtained by mercury penetration method, using Micrometrix Poresizer 9320 (produced by Shimadzu Corporation). The measurement of pore sizes by the mercury penetration method was calculated using the following formula, which was derived on the assumption that a cross section of the pores is a circular form.
D=−4γ COS θ/P

D: pore diameter, γ: surface tension of mercury, θ: contact angle, P: pressure

The surface tension of the mercury was adjusted to 482.536 dyn/cm and the used contact angle was adjusted to 130°. Then, high pressure part measurement (0 to 30000 psia, measured pore size: 6 to 6 nm) was conducted. The average pore volume of the ink absorbing layer is calculated from the mass of the ink absorbing layer previously determined and the void volume distribution curve. In the pore distribution curve of the ink absorbing layer of the present invention, as a peak exists in the range of 6 nm to 150 nm and a base of the peak often extends to 1 μm, the pore volume in the range of 6 nm to 1 μm was accumulated and calculated.

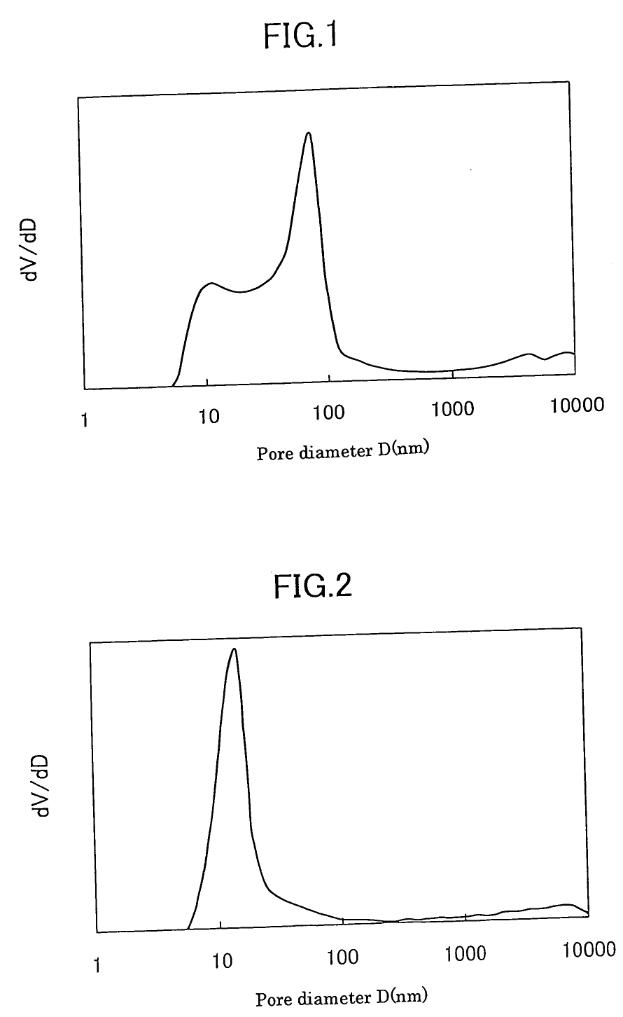

Next, herein describe is a porous ink absorbing layer which is essential in the present invention. The porous ink absorbing layer in the present invention has the porous ink absorbing layer containing fine particle silica having the average particle size of 0.5 μm or smaller produced by wet process, electrolytes, and polyvinyl alcohol, and formed by the above methods. The porous ink absorbing layer preferably has the following features in the pore distribution in order to acquire an ink-jet recording sheet which has the excellent ink absorption speed and ink absorption capacity, and does not produce defects of the coating due to the cracks generated during drying in production processes, which are features of the present invention. Namely, it has a feature that the pore distribution curve obtained by measurement with the mercury porosimetry has two peaks or one wide peak having shoulders in the range of a pore diameter of 6 nm to 150 nm as shown in FIG. 1. It is preferable that one of the two peaks exists within 8 nm to 25 nm or that one wide range of peak having shoulders extends to the range of 8 nm to 25 nm. Since the pores within the range have a strong capillary force, they have an advantage that it can quickly absorb the discharged ink. On the other hand, the pores have a defect that they easily produce defects of the coating due to the cracks generated during drying process of the ink absorbing layer. However, when the pores have features that they have another pore peak in the range of the pore size of 6 nm to 150 nm or that they have one but wide range of peak, cracking of the ink absorbing layer can be prevented in drying process because the contractile force due to the capillary force is reduced by existence of many pores having a large diameter. Further, since the pore volume contributing to ink absorption increases by existence of many pores having a large diameter, a large quantity of ink absorbed once can further be quickly absorbed by the pores existing in the range of 8 nm to 25 nm. Thus, the porous ink absorbing layer can absorb ink without overflowing when ink is continuously discharged.

In Examples of Japanese Unexamined Publication No. Hei 9-183267, an example that two peaks appeared within the above range is described. However, those two peaks mean that, when two ink absorbing layers were provided, one peak at a time which existed in each of the absorbing layers appeared. On the other hand, the porous ink absorbing layer of the present invention has two peaks or one wide peak having shoulders in the range of the pore diameter of 6 nm to 150 nm in at least one absorbing layer(s). The feature of the present invention that two peaks exist in one absorbing layer is different from that of Japanese Unexamined Publication No. Hei 9-183267.

When the peak of the pore diameter exists only in the range less than 6 nm, sufficient ink absorption speed cannot be obtained, and there is a risk of occurring ink overflow or uneven print density known as beading. In the absorbing layer wherein the peak of the pore diameter exists only in the range more than 150 nm, ink tend to spread and there is a risk that the vivid images cannot be obtained. Besides, there are also risks that the print density lowers due to the decrease of transparency and that gloss is deteriorated.

In the pore distribution curve of the porous ink absorbing layer measured by the above method, an absolute value of difference between a mode pore diameter and median pore diameter is preferably 10 nm or more, and more preferably more than 20 nm. Larger the difference between the mode pore diameter and the median pore diameter is, wider the peak is. The shoulders can also be more clearly identified, and, finally, the shoulders are separated as each clear peaks and thus become two peaks. When the difference is less than 10 nm, the peak in the pore distribution curve becomes one sharp peak. It may cause cracking in coating and drying the ink absorbing layer because the size of the pores does not vary and the contractile force due to the capillary force is not easily reduced. The upper limit of the value of the difference is, though it is not limited, preferably less than 100 nm or so.

The pore volume of the porous ink absorbing layer in the range of pore diameter from 6 nm to 1 μm, which was measured by the above method, is 0.5 to 2.0 ml/g, preferably 0.5 to 1.8 ml/g, and more preferably 0.6 to 1.5 ml/g. When the volume of the pores having a pore diameter in the range of 6 nm to 1 μm is larger than 0.5 ml/g, the ink absorbing layer can sufficiently absorb a large quantity of discharged ink. Therefore, images are not distorted by ink overflow. Meanwhile, the volume of the pores having a pore diameter in the range of 6 nm to 1 μm is 2.0 ml/g or smaller, colorants are highly fixed and strength of the ink absorbing layer is also high.

In the present invention, the ink-jet recording sheets having gloss like that of photographic printing paper are obtained by providing a gloss layer on the above porous ink absorbing layer. Though the methods for providing the gloss layer are not particularly limited, the following two embodiments are suitably used in order to obtain gloss like that of photographic printing paper and to combine high ink absorption speed with high ink absorption capacity.

The first embodiment is that a coating liquid containing fine particle pigments is coated on the porous ink absorbing layer of the present invention and dried, and at least one gloss layer(s) is provided. Various pigments can be used as the fine particle pigments. Silica having the average particle size of 0.5 μm or smaller, aluminum hydroxide, boehmite, p-boehmite, or alumina has a large pore volume and has excellent ink absorbability. The fine particle pigments are preferably secondary particles comprising the primary particles having the average primary particle size of 5 to 100 nm and preferably 6 to 40 nm since the pore volume becomes large. The average particle size of the secondary particles wherein those primary particles aggregate is 0.5 μm or smaller, preferably 9 to 800 nm, more preferably 10 to 600 nm, and most preferably 15 to 400 nm.

In case of using colloidal silica, especially high gloss is obtained.

As binder resins which are contained in the above coating liquid, water dispersible resins or water-soluble polymers can be used, and water-soluble polymers are preferable. For example, they include water-soluble resing such as polyvinyl alcohol, polyethylene oxide, polyalkylene oxide, polyvinyl pyrrolidone, water-soluble polyvinyl acetal, poly-N-vinylacetoamide, polyacrylamide, polyacryloyl morpholine, polyhydroxy alkylacrylate, polyacrylic acid, hydroxyethyl cellulose, methylcellulose, hydroxypropyl methylcellulose, hydroxypropyl cellulose, gelatin and casein; and water-soluble derivatives thereof. Though water dispersible resins such as SBR latex and NBR latex can be used, water-soluble resins are preferable. Those resins can be used not only by its own but also by mixing two kinds or more thereof.

The coated amount of the gloss layer is preferably 0.5 to 10 g/m² as mass after drying and further preferably 2 to 8 g/m². When the amount is less than 0.5 g/m², there is a risk of insufficient gloss. When the amount is more than 10 g/m², there is a risk of cracking in drying.

In case of using silica as the fine particle pigment(s) in the gloss layer, cationic modified silica is suitably used in order to fix ink better. For example, in Japanese Patent Unexamined Publication No. 2001-80204, ink-jet recording sheets are obtained such as those combining high gloss with high print density by coating a coating liquid containing slurry mixture wherein dispersions containing fumed silica and cationic compounds were dispersed or cracked into the average particle size of 1 μm or smaller with mechanical crushing.

The second embodiment is the method that the gloss layer is provided by the cast method (hereinafter referred to as a cast coated layer). The cast method is that a coated layer is dried on a cast drum having a smooth surface made of mirror-finished metal, plastic glass, etc., mirror-finished metal plates, plastic sheets, films (film transfer cast method, film cast method), or glass plates; and the smooth surface is copied on the coated layer to obtain a smooth and glossy coated layer surface. As the methods for providing the cast coated layer using a mirror drum, the following methods are included as examples: that a coating liquid for a cast coated layer is coated on the porous ink absorbing layer of the present invention and the coated layer is welded with pressure on the heated mirror drum while it is in wet condition and dried to complete (wetcast method); or that the coated layer is dried once and welded with pressure on the heated mirror drum after moistening the layer again and dried to complete (rewet-cast method). The method can be also adopted, such as that coating the coating liquid for the cast coated layer directly on the heated mirror drum; welding to the porous ink absorbing layer surface of the present invention with pressure; and drying to complete (precast method).

The surface temperature of the mirror drum is preferably 40 to 200° C. and more preferably 70 to 150° C. When it is lower than 40° C., drying takes time and there is a risk of deterioration in gloss and productivity. When it is higher than 200° C., the paper surface gets rough or gloss deteriorates in some cases.

In case that the coating liquid for the cast coated layer is coated on the porous ink absorbing layer of the present invention and the coated layer is welded with pressure on the heated mirror drum while it is in wet condition and dried to complete, the methods for promoting immobilization of the coating liquid for the cast coated layer can be also adopted in order to inhibit infiltration of the coating liquid for the cast coated layer. The examples of the methods are, (1) a gelatinizing agent(s) for promoting immobilization of the coating liquid for the cast coated layer is previously dispensed in the porous ink absorbing layer, (2) a gelatinizing agent(s) for promoting immobilization of the coating liquid for the cast coated layer is coated/impregnated on the porous ink absorbing layer, (3) after coating with the coating liquid for the cast coated layer, a gelatinizing agent(s) for promoting immobilization of the coating liquid for the cast coated layer is coated/impregnated on the surface thereof, and (4) a gelatinizing agent(s) for promoting immobilization of the coating liquid for the cast coated layer is dispensed in the drying process during the coating liquid for the cast coated layer is coated. As such gelatinizing agents, they include a boric acid, a formic acid, and salts thereof, aldehyde compounds, epoxy compounds, which is a cross-linking agent of an adhesive agent in the coating liquid for the cast coated layer. In case of adopting a wetcast method among the above methods, gloss easily expresses when the time is shortened until when the cast coating liquid is coated on the porous ink absorbing layer and the coated layer is welded with pressure on the mirror drum and dried, because infiltration of the coating liquid is inhibited. It is particularly preferable to adopt the method comprising the steps of giving the cast coating liquid between the surface of the porous ink absorbing layer on the welding roller (press roller) and the mirror drum just before the porous ink absorbing layer is welded with pressure on the drum; and welding with pressure at once (called nip cast method), because infiltration of the coating liquid is inhibited as much as possible and it is easier to obtain high gloss and high print quality by small coated amount.

The coating liquid for the cast coated layer is not particularly limited. For example, as disclosed in Japanese Unexamined Publication No. Hei 7-089220, there is a coating liquid containing polymers having the glass transition point of preferably 40° C. or higher, which are formed by polymerizing monomers having ethylene unsaturated bond hereinafter referred to as ethylene monomer). The examples of polymers which are formed by polymerizing monomers having ethylene unsaturated bond (hereinafter referred to as ethylene monomer) are the polymers obtained by polymerizing acrylic esters having 1 to 18 carbon atoms of an alkyl group, such as methyl acrylate, ethyl acrylate, butyl acrylate, 2-ethylhexyl acrylate, lauryl acrylate, 2-hydroxyethyl acrylate, and glycidyl acrylate; esters of methacrylic acids having 1 to 18 carbon atoms of an alkyl group, such as methylmethacrylate, ethylmethacrylate, 2-hydroxyethylmethacrylate, 2-hydroxypropylmethacrylate, and glycidyl methacrylate; and ethylene monomers such as styrene, α-methylstyrene, vinyl toluene, acrylonitrile, vinyl chloride, vinylidene chloride, vinyl acetate, vinyl propionate, acrylamide, N-methylolacrylamide, ethylene, and butadiene. They may be copolymers using two kinds or more of ethylene monomers together, if necessary, or they can copolymerize other monomers. Among the above examples, styrene-acrylic ester(s) copolymer or styrene-ester(s) of methacrylic acid(s) copolymer is particularly preferable.

Further, polymers may be a substituted derivative(s) of the polymers or the copolymers. For example, the substituted derivatives include those made carboxylation or those further having alkaline reactivity. It is also possible to use the above ethylene monomers in the form of a complex which is made by polymerizing the ethylene monomers under the existence of colloidal silica and then by Si—O—R (R: polymer component) bonding. The polymers which are obtained by polymerizing the ethylene monomers preferably have the glass transition point of 40° C. or higher, more preferably in the range of about 50 to 100° C., and most preferably about 70 to 90° C. The glass transition point is controlled, for example, by the kinds of the ethylene monomers or the degree of cross-linkage of polymers. For example, the glass transition point can be raised by containing 50 weight % or more of the monomer such as styrene, which comparatively raises the glass transition point. In the coating liquid for the cast coated layer, the pigments such as colloidal silica can be dispensed in addition to the above polymers, and the amount thereof is preferably about 1 part by weight to 200 parts by weight to 100 parts by weight of the polymer. Urethane resins can be also used.

In the coating liquid for the cast coated layer, various auxiliary agents used for usual print enamel paper or ink-jet sheets such as pigments, antifoamers, colorants, fluorescent brighteners, antistatic agents, antiseptics, dispersants, and thickeners are accordingly added thereto in order to control whiteness, viscosity, or flowability. Further, mold-releasing agents are preferably added to the coating liquid for the cast coated layer in order to give demolding from a cast drum, etc.

The examples of the mold-releasing agents are higher fatty acid amide such as stearamide and oleic amide; polyolefin waxes such as polyethylene wax, oxidized polyethylene wax, and polypropylene wax; higher fatty acid alkali salts such as calcium stearate, zinc stearate, potassium oleate, and ammonium oleate; silicon compounds such as lecithin, silicon oil and silicon wax; and fluorine compounds such as polytetrafluoroethylene. The blending quantity of the mold-releasing agent is controlled in the range of 0.1 to 50 parts by weight, preferably 0.3 to 30 parts by weight and more preferably 0.5 to 20 parts by weight to 100 parts by weight of the pigment. Here, when the blending quantity is not enough, there is a risk that the effect of improved mold release can not sufficiently be obtained. When it is too much, gloss is deteriorated or ink rejection or deterioration of the recording density occurs in some cases.

It is possible to combine the first embodiment with the second embodiment. Namely, the coating liquid containing the fine particle pigments is coated on the porous ink absorbing layer of the present invention and dried in accordance with the first embodiment to have at least one gloss layer. Then, in accordance with the second embodiment, the gloss layer can be provided by the cast method. Gloss is particularly excellent in this method.

When the gloss layer is provided by the above method, 75 degree C. specular gloss of the ink-jet recording sheet of the present invention is preferably 40% or higher, more preferably 50% or higher and most preferably 70% or more.

In order to inhibit curling of the ink-jet recording sheets or improve transportation, a reverse layer can be provided on the opposite side of the ink absorbing layer on the support. The structure of the reverse layer and the accompanied reverse layer of the support can be selected as its usage and are not particularly limited. However, in consideration of coating and cost, it is suitable to have a reverse layer which is mainly comprised of hydrophilic resins. An adhesive layer and a peeling sheet may be provided on the reverse surface.

Next, Examples will further illustrate the present invention. The following Examples only explain the present invention and do not particularly limit the invention. Meanwhile, as long as it is not particularly mentioned, “%” representing the concentration indicates weight %, and “part” indicates a part by weight in the Examples.

[Method for Measuring the Pore Volume and Pore Diameter of Silica]

A water dispersion of silica was dried at 105° C. and the pore volume and pore diameter distribution of the obtained powder test material were determined with surface area and pore size analyzer by gas adsorption (Coulter, SA3100plus type) after vacuum degassing at 200° C. for 2 hours as pretreatment. Nitrogen was used as the adsorption gas. As the pore volume, the value of all the pore volume were used of the pores having a pore size of 100 nm or smaller. The pore diameter was defined as that of the maximum volume fraction in the pore distribution curve obtained from analysis by BJH method of desorption isotherm.

[Method for Measuring the Average Secondary Particle Size of Silica]

The water dispersion of silica was measured in the sufficiently diluted condition with distilled water using a laser particle size analyser (Otsuka Electronics Co., Ltd., LPA3000/3100) by the dynamic light scattering method. As the average particle size, the value calculated from analysis using the cumulant method was used.

[Method for Producing Fine Particle Silica Dispersion Liquid A]

Synthetic amorphous silica (produced by Grace Davison (W.R. Grace & Co.), trade name: Sylojet P612, specific surface area: 290 m²/g, primary particle size: 9 nm) having the average particle size of 13.1 μm which was produced by gel method was dispersed in water in the concentration of 20%. Ammonia water was added thereto to adjust its pH to 9.0. The obtained slurry was repeatedly dispersed by crashing with a horizontal bead mill (produced by Shinmaru Enterprises Corporation, Dyno-Mill KDL-Pilot) to produce 20% water dispersion liquid of silica having the average secondary particle size of 300 nm. The specific surface area of the fine particle silica pigments was 290 m²/g, and their pore volume was 0.7 ml/g.

[Method for Producing Fine Particle Silica Dispersion Liquid B]

(Preparation of an Aqueous Solution of an Active Silicic Acid)

Distilled water was mixed with a solution of sodium silicate (produced by Tokuyama Corporation, sodium silicate No. 3) wherein SiO₂ concentration is 30% and SiO₂/Na₂O is 3.1 to prepare an aqueous solution of dilute silicate of soda wherein SiO₂ concentration is 4.0%. The aqueous solution was passed through a column filled with a hydrogenous cation-exchange resin(s) (produced by Mitsubishi Chemical Corporation, Diaion SK-1BH) to prepare an aqueous solution of an active silicic acid. SiO₂ concentration in the obtained aqueous solution of the active silicic acid was 4.0%, and its pH was 2.9.

(Preparation of a Seed Solution)

In a 5-liter reaction container made of glass with a reflux condenser, a mixer and a thermometer, 400 g of distilled water was heated to 100° C. Keeping the hot water to 100° C., total of 480 g of the above aqueous solution of the active silicic acid was added at a speed of 8 g/min. to prepare a seed solution.

(Preparation of Fine Particle Silica Dispersion Liquid)

13.5 g of potassium hydroxide solution whose concentration is 1 mmol/L was temporarily added to the above seed solution to stabilize. Keeping the seed solution to 100° C., 920 g of the above aqueous solution of the active silicic acid was added at a speed of 8 g/min. After finishing its addition, heating under reflux was conducted for 1 hour keeping the solution to 100° C. to obtain a fine particle silica dispersion liquid. The dispersion liquid was light milky white transparent solution, and its pH was 8.6. The properties of the fine particle silica dispersion liquid were as follows: the average secondary particle size: 99 nm, the primary particle size: 14 nm, the specific surface area: 193 m²/g, the pore volume: 0.62 ml/g, and pore size: 13.5 nm. The dispersion liquid was concentrated with the evaporator to become 20% silica concentration. The hydrogenous cation-exchange resin(s) (produced by Mitsubishi Chemical Corporation, Diaion SK-1BH) was put and stirred, and potassium hydroxide was removed therefrom. Then, the liquid was adjusted by ammonia water to pH 9.0 and used for producing ink-jet recording sheets.

[Method for Producing Fine Particle Silica Dispersion Liquid C]

Silica (produced by Nippon Aerosil Co., Ltd., trade name: AEROSIL130) having the average primary particle size of 20 nm which was produced by gas-phase method was dispersed in water in its concentration of 20%. Its pH was adjusted to 2.5 by hydrochloric acid and dispersed three times with a hydraulic extra-high pressure homogenizer (produced by Mizuho Industrial Co., Ltd., Microfluidizer M110-E/H) to produce 20% water dispersion liquid of silica having the average secondary particle size of 250 nm. The specific surface area of the fine particle silica pigments was 137 m²/g, and their pore volume was 1.2 ml/g.

[Method for Producing Cation-Denaturalized Fine Particle Silica Dispersion Liquid D]

11% water dispersion liquid of silica (produced by Nippon Aerosil Co., Ltd., trade name: AEROSIL300) having the average primary particle size of 9 nm which was produced by gas-phase method was dispersed three times with the hydraulic extra-high pressure homogenizer, which was used in the method for producing silicazol C. The specific surface area of the fine particle silica was 308 m²/g, and their pore volume was 1.6 ml/g. 10 parts of 11% aqueous solution of diallyldimethylammonium chloride-acrylamide copolymer (produced by Nitto Boseki Co., Ltd., trade name: PAS-J-81), which was a cationic resin as an ink fixing agent were added to 100 parts of the dispersion liquid. The gelatinized mixture was repeatedly dispersed by the above homogenizer to produce a water dispersion liquid of silica having the average secondary particle size of 100 nm. The dispersion liquid had the 11% solid concentration, 10% silica concentration and 1% concentration of diallyldimethylammonium chloride-acrylamide copolymer.

[Method for Producing a Coating Liquid E for a Cast Coated Layer]

100 parts of 50:50 complex of styrene-2-methylhexylacrylate copolymeric resin having the glass transition point of 85° C. and colloidal silica having the average particle size of 30 nm; 5 parts of alkylvinyl ether-maleic acid derivative resin as a viscosity modifier; and 3 parts of lecithin as a mold-releasing agent were mixed and dispersed in water to produce a coating liquid for a cast coated layer having 11% solid concentration.

[Method for Producing Fine Particle Silica Dispersion Liquid F]

In the same method as that of the fine particle silica dispersion liquid B, silica was produced such as those having an almost same specific surface area and a larger pore volume compared with the dispersion liquid B. Used active silicic acid and the equipments for the production are the same.

400 g of distilled water was heated to 100° C. in a reaction container made of glass. Keeping the hot water to 100° C., total of 1120 g of the above aqueous solution of the active silicic acid was added at a speed of 16 g/min. to prepare a seed solution.

27 g of potassium hydroxide solution whose concentration is 1 mmol/L was temporarily added to the above seed solution to stabilize. Keeping the seed solution to 100° C., 1760 g of the above aqueous solution of the active silicic acid was further added at a speed of 16 g/min. After finishing its addition, heating under reflux was conducted for 1 hour keeping the solution to 100° C. to obtain a fine particle silica dispersion liquid. The dispersion liquid was light milky white transparent solution, and its pH was 8.8. The properties of the fine particle silica dispersion liquid were as follows: the average secondary particle size: 154 nm, the primary particle size: 14 nm, the specific surface area: 198 m²/g, and the pore volume: 1.10 ml/g. The dispersion liquid was concentrated with the evaporator to become 20% silica concentration. The hydrogenous cation-exchange resin(s) (produced by Mitsubishi Chemical Corporation, Diaion SK-1BH) was put and stirred, and potassium hydroxide was removed therefrom. Then, the liquid was adjusted by ammonia water to pH 9.0 and used for producing ink-jet recording sheets.

[Method for Producing Fine Particle Silica Dispersion Liquid G]

In the same method as that of the fine particle silica dispersion liquid B, silica was produced such as those having an almost same specific surface area and a smaller pore volume compared with the dispersion liquid B. Used active silicic acid and the equipments for the production are the same.

400 g of distilled water was heated to 100° C. in a reaction container made of glass. Keeping the hot water to 100° C., total of 360 g of the active silicic acid was added at a speed of 16 g/min. to prepare a seed solution.

9 g of potassium hydroxide solution whose concentration is 1 mmol/L was temporarily added to the above seed solution to stabilize. Keeping the seed solution to 100° C., total of 560 g of the above aqueous solution of the active silicic acid was further added at a speed of 16 g/min. After finishing its addition, heating under reflux was conducted for 1 hour keeping the solution to 100° C. to obtain a fine particle silica dispersion liquid. The dispersion liquid was a transparent solution having a light blue tinge, and its pH was 8.8. The properties of the fine particle silica dispersion liquid were as follows: the average secondary particle size: 5 nm, the primary particle size: 14 nm, the specific surface area: 190 m²/g, and the pore volume: 0.35 ml/g. The dispersion liquid was concentrated with the evaporator to become 20% silica concentration. The hydrogenous cation-exchange resin(s) (produced by Mitsubishi Chemical Corporation, Diaion SK-1BH) was put and stirred, and potassium hydroxide was removed therefrom. Then, the liquid was adjusted by ammonia water to pH 9.0 and used for producing ink-jet recording sheets.

[Production of Support Base Paper]

Needle bleached kraft pulp (NBKP) which was beaten until CSF (JIS P-8121) reached 250 ml and L-bleached kraft pulp (LBKP) which was beaten until CSF reached 280 ml were mixed in a mass ratio of 2:8 to prepare a pulp slurry of 0.5% concentration. To the absolute dry weight of pulp, 2.0% cationized starch, 0.4% alkylketene dimer, 0.1% anionized polyacryl amide resin, and 0.7% polyamide polyamine epichlorohydrin resin were added to the pulp slurry, and sufficiently stirred and dispersed. Paper was made from the pulp slurry having the above-mentioned composition with a Fourdrinier machine and passed through a drier, a size-press, and a machine calendar to obtain a base paper having a basic weight of 180 g/m², and a density of 11.0 g/cm³. The size press solution used in the above-mentioned size press process was prepared by mixing carboxyl denaturalized polyvinyl alcohol with sodium chloride in mass ratio of 2:1, adding water thereto, dissolving the mixture by heating it, and adjusting the concentration thereof to 5%. The size press solution was coated, in total amount of 25 cc, on both sides of paper to obtain a support base paper.

[Production of a Support]

After practicing the corona discharge treatment on the both sides of the support base paper, a following polyolefin resin composition 1 which was mixed and dispersed with Banbury mixer was coated on the felt side of the base paper to become the coated amount of 25 g/m² and a polyolefin resin composition 2 (a resin composition for a back side) was coated on the wire side of the base paper to become the coated amount of 20 g/m² using a melt extrusion machine having T-type die (melting temperature 320° C.). The felt side was solidified by cooling with a mirror cooling roller and the wire side was solidified by cooling with a rough-surfaced cooling roller to produce support coated with resin wherein a degree of smoothness of the surface (Oken type model, J. Tappi No. 5) was 6000 seconds and the opacity (JIS P8138) was 93%.

(Polyolefin resin composition 1) long-chain low-density polyethylene resin (density 0.926 g/cm³, met index 20 g/10 mins.) 35 parts, low-density polyethylene resin (density 0.919 g/cm³, met index 2 g/10 mins.) 50 parts, anatase titanium dioxide (A-220, produced by Ishihara Sangyo Kaisha, Ltd.) 15 parts, zinc stearate 0.1 part, antioxidant (Irgano×1010, produced by Ciba-Geigy Ltd.) 0.03 part, ultramarine blue (ultramarine blue with blue tinge, produced by Daiichikasei Co., Ltd.) 0.09 part, fluorescent brightener (UVITEX OB, produced by Ciba-Geigy Ltd.) 0.3 part

(Polyolefin resin composition 2) high-density polyethylene resin (density 0.954 g/cm³, met index 20 g/10 mins.) 65 parts, low-density polyethylene resin (density 0.924 g/cm³, met index 4 g/10 mins.) 35 parts

### EXAMPLE 1

0.5 part of 10% aqueous solution of sodium chloride and 40 parts of 10% aqueous solution of polyvinyl alcohol (produced by Kuraray Co., Ltd., trade name: PVA-140) of which the degree of saponification was 98.5% and that of polymerization was 4000 were mixed to 100 parts of fine particle silica dispersion liquid A to prepare a coating (paint) having 17.1% solid concentration wherein 0.25 part of sodium chloride and 20 parts of polyvinyl alcohol were contained to 100 parts of silica. Ion-exchange water was added thereto to make the concentration to 16.0%. The main component of the coating and pH were indicated in Table 1. The coating was bar-coated on the support so that the coating amount became 20 g/m² in dry weight. Thus coated layer was dried at 120° C. to provide a porous ink absorbing layer.

Next, the coating liquid wherein 22 parts of the above 10% aqueous solution of polyvinyl alcohol of which the degree of saponification was 98.5% were mixed with 100 parts of cation-denaturalized fine particle silica dispersion liquid D (concentration: 11%) was bar-coated on the ink absorbing layer so that the coating amount became 5 g/m² in dry weight. Thus coated layer was dried at 120° C. to provide a gloss layer and produced an ink-jet recording sheet. The method for laminating the gloss layer of the ink-jet recording sheet was indicated in Table 1. The pore distribution of the porous ink absorbing layer, cracking, surface pH and quality of the ink-jet recording sheet were evaluated in the following method and shown in Table 2.

[Measurement of the Pore Distribution of the Porous Ink Absorbing Layer]

The measurement of the pore distribution of the porous ink absorbing layer of the ink-jet recording sheets were practiced by using an ink absorbing layer which had not the gloss layer yet in the Examples and Comparative Examples of the present invention. Coating for the ink absorbing layer was coated on PET film, and a sample which was peeled off by a knife was measured. The pore distribution was calculated from the void volume distribution curve obtained by mercury penetration method, using Micrometrix Poresizer 9320 (produced by Shimadzu Corporation), and peak position and a mode pore diameter were determined. Further, the pore volume in the range of 6 nm to 1 μm was accumulated and calculated from the obtained pore distribution curve. In the absorbing layer of each Examples and Comparative Examples, number of peaks in the range of pore size of 6 to 150 nm, the peak position, mode pore diameter, median pore diameter, an absolute value of difference between a mode pore diameter and median pore diameter and the pore volume in the range of pore size of 6 nm to 1 μm were indicated in Table 2.

[Cracking of the Porous Ink Absorbing Layer]

Evaluation of cracking of the porous ink absorbing layer in the present invention was practiced by visual check using an ink absorbing layer which had not the gloss layer yet. The cracking status in 10 cm×10 cm sheet was evaluated at the following three phases.

⊚: no crack

◯: several cracks of 1 mm or longer exist but status is good

x: cracks exist on the entire surface and status is practically problematic

[Surface pH of the Porous Ink Absorbing Layer]

Evaluation of the surface pH of the porous ink absorbing layer in the present invention was practiced using an ink absorbing layer which had not the gloss layer yet, in accordance with the method described in J. Tappi pulp and paper examination No. 49. Distilled water was used therein and value of the surface pH measured 30 seconds later was regarded as the surface pH.

Methods for Evaluating Quality of the Ink-Jet Recording Sheet

[75 Degree C. Specular Gloss]

It was measured in accordance with JIS standard P8142.

[Ink Absorption Speed]

The ink absorption speed of the ink-jet recording sheet in the present invention was evaluated by the following method. All one color of each of 100% Cyan, 100% Magenta, 100% Yellow and 100% Black was printed on the ink-jet recording sheet by an ink-jet printer (produced by EPSON, PM-800C) in print mode recommending special sheets for superfine print quality. A PPC sheet was pressed on the printed part by hand and visually checked whether ink was transcribed. The time taken until no transcription occurred was measured and evaluated at the following three phases.

⊚: less than 1 second

◯: 1 second or more and less than 30 seconds

x: 30 seconds or more

[Ink Absorption Amount]

The ink absorption amount of the ink-jet recording sheet in the present invention was evaluated in the following method. In accordance with the above method, all mixed colors of 100% red, 100% green and 100% blue were printed on the ink-jet recording sheet. Then, presence of ink overflow and uniformity of the print density were evaluated at the following three phases.

⊚: no ink overflow and good uniformity

◯: no ink overflow but slightly uneven density

x: ink overflow occurs

### EXAMPLE 2

0.5 part of 10% aqueous solution of sodium sulfate and 40 parts of 10% aqueous solution of polyvinyl alcohol used in Example 1 were mixed to 100 parts of fine particle silica dispersion liquid A to prepare a coating having 17.1% solid concentration wherein 0.25 part of sodium sulfate and 20 parts of polyvinyl alcohol were contained to 100 parts of silica. The porous ink absorbing layer and the gloss layer were provided by the same method as that of Example 1 except for using 16.0% coating which was diluted by addition of ion-exchange water to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 3

1 part of 10% aqueous solution of sodium sulfate and 40 parts of 10% aqueous solution of polyvinyl alcohol (produced by Kuraray Co., Ltd., trade name: PVA-635) of which the degree of saponification was 95.0% and that of polymerization was 3500 were mixed to 100 parts of fine particle silica dispersion liquid A to prepare a coating having 17.1% solid concentration wherein 0.5 part of sodium sulfate and 20 parts of polyvinyl alcohol were contained to 100 parts of silica. The porous ink absorbing layer and the gloss layer were provided by the same method as that of Example 1 except for using 16.0% coating which was diluted by addition of ion-exchange water to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 4

0.5 part of 10% aqueous solution of sodium carbonate and 40 parts of 10% aqueous solution of polyvinyl alcohol used in Example 1 were mixed to 100 parts of fine particle silica dispersion liquid A to prepare a coating liquid having 17.1% solid concentration wherein 0.25 part of sodium carbonate and 20 parts of polyvinyl alcohol were contained to 100 parts of silica. The porous ink absorbing layer and the gloss layer were provided by the same method as that of Example 1 except for using 16.0% coating which was diluted by addition of ion-exchange water to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 5

1 part of 10% aqueous solution of sodium chloride and 40 parts of 10% aqueous solution of polyvinyl alcohol used in Example 1 were mixed to 100 parts of fine particle silica dispersion liquid B to prepare a coating having 17.1% solid concentration wherein 0.5 part of sodium chloride and 20 parts of polyvinyl alcohol were contained to 100 parts of silica. The porous ink absorbing layer and the gloss layer were provided by the same method as that of Example 1 except for using 16.0% coating which was diluted by addition of ion-exchange water to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 6

2 parts of 10% aqueous solution of sodium sulfate and 40 parts of 10% aqueous solution of polyvinyl alcohol used in Example 1 were mixed to 100 parts of fine particle silica dispersion liquid B to prepare a coating having 16.9% solid concentration wherein 1 part of sodium sulfate and 20 parts of polyvinyl alcohol were contained to 100 parts of silica. The porous ink absorbing layer and the gloss layer were provided by the same method as that of Example 1 except for using 16.0% coating which was diluted by addition of ion-exchange water to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2. Shoulders of the pore peak in Table 2 smoothly exist extending to 10 to 20 nm.

### EXAMPLE 7

The porous ink absorbing layer was provided on the support in accordance with Example 1. Then, a coating liquid E for a cast coated layer was coated on the ink absorbing layer with a roll coater, and at once welded with pressure on a mirror drum having the surface temperature of 75° C. After drying, the layer was mold-released to provide the gloss layer (cast coated layer) to produce the ink-jet recording sheet. The cast coating amount at that time was 5 g/m² in solid weight. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 8

The porous ink absorbing layer was provided on the support in accordance with Example 2. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 9

The porous ink absorbing layer was provided on the support in accordance with Example 3. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 10

The porous ink absorbing layer was provided on the support in accordance with Example 4. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 11

The porous ink absorbing layer was provided on the support in accordance with Example 5. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 12

The porous ink absorbing layer was provided on the support in accordance with Example 6. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2. Shoulders of the pore peak in Table 2 smoothly exist extending to 10 to 20 nm.

### EXAMPLE 13

The ink-jet recording sheet having the gloss layer was produced by the same method as that of Example 5 except for using a fine particle silica dispersion liquid F. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 14

The ink-jet recording sheet having the gloss layer was produced by the same method as that of Example 5 except for using a fine particle silica dispersion liquid G. The main component of the coating, pH and the method for laminating the gloss layer were indicated in Table 1. The pore distribution of the porous ink absorbing layer, cracking, surface pH and quality of the ink-jet recording sheet were shown in Table 2.

### EXAMPLE 15

The ink-jet recording sheet having the gloss layer was produced by the same method as that of Example 5 except that 1 part of 10% aqueous solution of sodium hydroxide was used instead of 1 part of 10% aqueous solution of sodium chloride. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 1

The porous ink absorbing layer and the gloss layer were provided on the support to obtain the ink-jet recording sheet by the same method as that of Example 1 except that sodium chloride was not added thereto. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 2

40 parts of 10% aqueous solution of polyvinyl alcohol (produced by Kuraray Co., Ltd., trade name: PVA-235) of which the degree of saponification was 88.0% and that of polymerization was 3500 were mixed to 100 parts of fine particle silica dispersion liquid A to prepare a coating having 17.1% solid concentration wherein 20 parts of polyvinyl alcohol were contained to 100 parts of silica. The porous ink absorbing layer and the gloss layer were provided by the same method as that of Example 1 except for using 16.0% coating which was diluted by addition of ion-exchange water (no addition of electrolytes) to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 3

The porous ink absorbing layer and the gloss layer were provided to obtain the ink-jet recording sheet by the same method as that of Example 5 except that sodium chloride was not added thereto. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 4

The porous ink absorbing layer was provided on the support in accordance with Comparative Example 1. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 5

The porous ink absorbing layer was provided on the support in accordance with Comparative Example 2. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 6

The porous ink absorbing layer was provided on the support in accordance with Comparative Example 3. Then, the gloss layer (cast coated layer) was provided by the same method as that of Example 7 to produce the ink-jet recording sheet. The main component of the coating, pH and the method for laminating the gloss layer were indicated in Table 1. The pore distribution of the porous ink absorbing layer, cracking, surface pH and quality of the ink-jet recording sheet were shown in Table 2.

### COMPARATIVE EXAMPLE 7

40 parts of 10% aqueous solution of polyvinyl alcohol used in Example 1 was mixed to 100 parts of fine particle silica dispersion liquid C to prepare a coating having 17.0% solid concentration wherein 20 parts of polyvinyl alcohol were contained to 100 parts of silica. The porous ink absorbing layer was provided by the same method as that of Example 1 except for using 16.0% coating which was diluted by addition of ion-exchange water. Since the obtained absorbing layer included many large cracks, many parts were peeled off from the support, and, therefore, coating liquid was not able to be coated on it. Thus, it was not possible to have the gloss layer. The main component of the coating and pH were indicated in Table 1. The pore distribution of the porous ink absorbing layer, cracking and surface pH were shown in Table 2.

TABLE 1

| | Main components of water-based coating liquid | | | | |
|---|---|---|---|---|---|
| | | | | electrolytes | |
| | pigments | | | | added |
| | (fine particle silica | polyvinyl alcohol | | | amount |
| | dispersion liquid) | saponification | polymerization | variety | (part by wt.) |
| Exam. 1 | dispersion | 98.5 | 4000 | sodium | 0.25 |
| | liquid A | | | chloride | |
| Exam. 2 | dispersion | 98.5 | 4000 | sodium | 0.25 |
| | liquid A | | | sulfate | |
| Exam. 3 | dispersion | 95.0 | 3500 | sodium | 0.5 |
| | liquid A | | | sulfate | |
| Exam. 4 | dispersion | 98.5 | 4000 | sodium | 0.25 |
| | liquid A | | | carbonate | |
| Exam. 5 | dispersion | 98.5 | 4000 | sodium | 0.5 |
| | liquid B | | | chloride | |
| Exam. 6 | dispersion | 98.5 | 4000 | sodium | 1.0 |
| | liquid B | | | sulfate | |
| Exam. 7 | dispersion | 98.5 | 4000 | sodium | 0.25 |
| | liquid A | | | chloride | |
| Exam. 8 | dispersion | 98.5 | 4000 | sodium | 0.25 |
| | liquid A | | | sulfate | |
| Exam. 9 | dispersion | 95.0 | 3500 | sodium | 0.5 |
| | liquid A | | | sulfate | |
| Exam. 10 | dispersion | 98.5 | 4000 | sodium | 0.25 |
| | liquid A | | | carbonate | |
| Exam. 11 | dispersion | 98.5 | 4000 | sodium | 0.5 |
| | liquid B | | | chloride | |
| Exam. 12 | dispersion | 98.5 | 4000 | sodium | 1.0 |
| | liquid B | | | sulfate | |
| Exam. 13 | dispersion | 98.5 | 4000 | sodium | 0.5 |
| | liquid F | | | chloride | |
| Exam. 14 | dispersion | 98.5 | 4000 | sodium | 0.5 |
| | liquid G | | | chloride | |
| Exam. 15 | dispersion | 98.5 | 4000 | sodium | 0.5 |
| | liquid B | | | hydroxide | |
| Comp. | dispersion | 98.5 | 4000 | (no | 0 |
| Exam. 1 | liquid A | | | addition) | |
| Comp. | dispersion | 88.0 | 3500 | (no | 0 |
| Exam. 2 | liquid A | | | addition) | |
| Comp. | dispersion | 98.5 | 4000 | (no | 0 |
| Exam. 3 | liquid B | | | addition) | |
| Comp. | dispersion | 98.5 | 4000 | (no | 0 |
| Exam. 4 | liquid A | | | addition) | |
| Comp. | dispersion | 88.0 | 3500 | (no | 0 |
| Exam. 5 | liquid A | | | addition) | |
| Comp. | dispersion | 98.5 | 4000 | (no | 0 |
| Exam. 6 | liquid B | | | addition) | |
| Comp. | dispersion | 98.5 | 4000 | (no | 0 |
| Exam. 7 | liquid C | | | addition) | |

| | pH of | |
|---|---|---|
| | coating | Method for laminating the gloss layer |
| Exam. 1 | 8.8 | Coating cation-denaturalized fine particle silica dispersion |
| | | liquid D |
| Exam. 2 | 8.8 | Coating cation-denaturalized fine particle silica dispersion |
| | | liquid D |
| Exam. 3 | 8.8 | Coating cation-denaturalized fine particle silica dispersion |
| | | liquid D |
| Exam. 4 | 8.7 | Coating cation-denaturalized fine particle silica dispersion |
| | | liquid D |
| Exam. 5 | 8.7 | Coating cation-denaturalized fine particle silica dispersion |
| | | liquid D |
| Exam. 6 | 8.7 | Coating cation-denaturalized fine particle silica dispersion |
| | | liquid D |
| Exam. 7 | 8.8 | Cast coating with coating liquid E for a cast coated layer |
| Exam. 8 | 8.8 | Cast coating with coating liquid E for a cast coated layer |
| Exam. 9 | 8.8 | Cast coating with coating liquid E for a cast coated layer |
| Exam. 10 | 8.7 | Cast coating with coating liquid E for a cast coated layer |
| Exam. 11 | 8.7 | Cast coating with coating liquid E for a cast coated layer |
| Exam. 12 | 8.7 | Cast coating with coating liquid E for a cast coated layer |
| Exam. 13 | 8.7 | Coating cation-denaturalized fine particle silica dispersion |
| | | liquid D |
| Exam. 14 | 8.7 | Coating cation-denaturalized fine particle silica dispersion |
| | | liquid D |
| Exam. 15 | 9.5 | Coating cation-denaturalized fine particle silica dispersion |
| | | liquid D |
| Comp. | 8.8 | Coating cation-denaturalized fine particle silica dispersion |
| Exam. 1 | | liquid D |
| Comp. | 8.6 | Coating cation-denaturalized fine particle silica dispersion |
| Exam. 2 | | liquid D |
| Comp. | 8.7 | Coating cation-denaturalized fine particle silica dispersion |
| Exam. 3 | | liquid D |
| Comp. | 8.8 | Cast coating with coating liquid E for a cast coated layer |
| Exam. 4 | | |
| Comp. | 8.6 | Cast coating with coating liquid E for a cast coated layer |
| Exam. 5 | | |
| Comp. | 8.7 | Cast coating with coating liquid E for a cast coated layer |
| Exam. 6 | | |
| Comp. | 2.6 | Lamination of the gloss layer is impossible due to cracking of |
| Exam. 7 | | ink absorbing layer |

TABLE 2

| | Pore distribution of the porous ink absorbing layer | | | | |
|---|---|---|---|---|---|
| | number and | | median | | |
| | position of | mode pore | pore size | | |
| | pore peak(s) | size d1 | d2 | \|d1 − d2\| | Pore vol. |
| | (nm) | (nm) | (nm) | (nm) | (ml/g) |
| Exam. 1 | two; 11, 61 | 61 | 45 | 16 | 0.79 |
| Exam. 2 | two; 10, 45 | 45 | 33 | 12 | 0.71 |
| Exam. 3 | two; 10, 63 | 63 | 46 | 17 | 0.82 |
| Exam. 4 | two; 11, 42 | 42 | 31 | 11 | 0.65 |
| Exam. 5 | two; 15, 55 | 55 | 41 | 14 | 1.06 |
| Exam. 6 | one; 44 | 44 | 32 | 12 | 0.94 |
| | (shoulders) | | | | |
| Exam. 7 | two; 11, 61 | 61 | 45 | 16 | 0.79 |
| Exam. 8 | two; 10, 45 | 45 | 33 | 12 | 0.71 |
| Exam. 9 | two; 10, 63 | 63 | 46 | 17 | 0.82 |
| Exam. 10 | two; 11, 42 | 42 | 31 | 11 | 0.65 |
| Exam. 11 | two; 15, 55 | 55 | 41 | 14 | 1.06 |
| Exam. 12 | one; 44 | 44 | 32 | 12 | 0.94 |
| | (shoulders) | | | | |
| Exam. 13 | one; 39 | 39 | 29 | 10 | 1.0 |
| Exam. 14 | two; 15, 45 | 45 | 33 | 12 | 0.51 |
| Exam. 15 | two; 15, 60 | 60 | 44 | 16 | 1.10 |
| Comp. | one; 13 | 13 | 14 | 1 | 0.48 |
| Exam. 1 | | | | | |
| Comp. | one; 16 | 16 | 16 | 0 | 0.40 |
| Exam. 2 | | | | | |
| Comp. | one; 21 | 21 | 20 | 1 | 0.45 |
| Exam. 3 | | | | | |
| Comp. | one; 13 | 13 | 14 | 1 | 0.48 |
| Exam. 4 | | | | | |
| Comp. | one; 16 | 16 | 16 | 0 | 0.40 |
| Exam. 5 | | | | | |
| Comp. | one; 21 | 21 | 20 | 1 | 0.45 |
| Exam. 6 | | | | | |
| Comp. | one; 11 | 11 | 11 | 0 | 0.82 |
| Exam. 7 | | | | | |

| | cracks of | pH of | quality of ink-jet recording sheet | | |
|---|---|---|---|---|---|
| | porous ink | porous ink | | ink | ink |
| | absorbing | absorbing | | absorption | absorption |
| | layer | layer | 75° gloss | speed | amount |
| Exam. 1 | ⊚ | 6.1 | 55 | ⊚ | ⊚ |
| Exam. 2 | ⊚ | 6.1 | 58 | ⊚ | ⊚ |
| Exam. 3 | ⊚ | 6.2 | 53 | ⊚ | ⊚ |
| Exam. 4 | ◯ | 6.1 | 57 | ◯ | ⊚ |
| Exam. 5 | ⊚ | 6.1 | 60 | ⊚ | ⊚ |
| Exam. 6 | ⊚ | 6.5 | 61 | ⊚ | ⊚ |
| Exam. 7 | ⊚ | 6.1 | 78 | ⊚ | ⊚ |
| Exam. 8 | ⊚ | 6.1 | 80 | ⊚ | ⊚ |
| Exam. 9 | ⊚ | 6.2 | 75 | ⊚ | ⊚ |
| Exam. 10 | ◯ | 6.1 | 78 | ◯ | ⊚ |
| Exam. 11 | ⊚ | 6.1 | 85 | ⊚ | ⊚ |
| Exam. 12 | ⊚ | 6.5 | 87 | ⊚ | ⊚ |
| Exam. 13 | ◯ | 6.1 | 64 | ◯ | ⊚ |
| Exam. 14 | ⊚ | 6.1 | 60 | ◯ | ◯ |
| Exam. 15 | ⊚ | 7.0 | 60 | ⊚ | ⊚ |
| Comp. | X | 6.1 | 28 | X | X |
| Exam. 1 | | | | | |
| Comp. | X | 6.2 | 27 | ◯ | X |
| Exam. 2 | | | | | |
| Comp. | X | 6.2 | 24 | ◯ | ◯ |
| Exam. 3 | | | | | |
| Comp. | X | 6.1 | 37 | X | X |
| Exam. 4 | | | | | |
| Comp. | X | 6.2 | 37 | X | X |
| Exam. 5 | | | | | |
| Comp. | X | 6.2 | 33 | X | X |
| Exam. 6 | | | | | |
| Comp. | X | 4.5 | Evaluation | Evaluation | Evaluation |
| Exam. 7 | | | impossible | impossible | impossible |

As shown in each Examples in Table 1, the feature of the present invention is that it comprises the steps of coating a support with a water-based coating liquid(s) containing wet-process fine particle silica, electrolytes and polyvinyl alcohol; drying it to form a porous ink absorbing layer; and then form a gloss layer on it. The large aggregation structure is formed in the porous ink absorbing layer by the effect of water-soluble salts, and the contractile force due to the capillary force is alleviated by the existence of many pores having a large diameter to prevent cracking in drying process. As a result, it is clarified from each Example in Table 2 that the porous ink absorbing layer of each Examples had two peaks or one wide peak having shoulders in the range of a pore diameter of 6 nm to 150 nm. Further, in each Examples, the pore diameter of the absorbing layer was larger compared to the pore diameter of pigments, and an absolute value of difference between a mode pore diameter and median pore diameter was 10 nm or more. Thus, the porous ink absorbing layer had a wide range of porous peaks wherein many large pores exist. Due to it, ink absorption speed was sufficiently fast and ink absorption capacity was also large. The degree of gloss of the ink-jet recording sheet was sufficiently high, too.

On the other hand, in case that a porous ink absorbing layer was obtained by coating a water-based coating liquid(s) without containing electrolytes and drying as shown in each Comparative Examples, since the large aggregation structure was not formed, the strong contractile force due to the capillary force could not be alleviated in drying process and many cracks occurred in the absorbing layer. Therefore, the degree of gloss was low when the gloss layer was formed in Comparative Examples 1 to 6. As the pore peak in the range of the above pore diameters was only once and the aggregation structure was not formed, the pore diameter of the absorbing layer was not large. Therefore, ink absorption speed was slow and ink absorption capacity was not sufficient because the pore volume did not easily become lager. In Comparative Example 7, since the obtained absorbing layer included many large cracks and many parts were peeled off from the support, the gloss layer was not formed on it.

As for the effect of kinds of silica, the pore volume of the ink absorbing layer was largest when the fine particle silica dispersion liquid B was used, which was produced by the polycondensation of active silicic acid. The ink absorption capacity was also large and the gloss was high, too. This fine particle silica met the formulae 1 and 2 simultaneously.
Specific surface area (m²/g)<730−600×Pore volume (ml/g) (Formula 1)
Specific surface area (m²/g)>450−600×Pore volume (ml/g) (Formula 2)

Though the fine particle silica dispersion liquid F is silica which was produced by the polycondensation of active silicic acid, it does not meet formula 1 but formula 2 only. In this case, the ink absorbing layer was slightly cracked. The fine particle silica dispersion liquid G is an example of silica which does not meet formula 2 but formula 1 only. In this case, the pore volume of the ink absorbing layer was somewhat smaller and the ink absorption capacity was also slightly smaller.

The ink-jet recording sheet of the present invention could be produced without defects of the coating due to the cracks, which becomes sometimes problematic when fine particle pigments are used. It also has gloss like that of photographic printing paper, the excellent ink absorption speed and ink absorption capacity. Therefore, it is suitable as alternative to silver salt photos.

What is claimed is:

1. An ink-jet recording sheet which, on at least one surface of a support, has a porous ink absorbing layer containing fine particle silica having the average particle size of 0.5 μm or smaller produced by wet process, electrolytes, and polyvinyl alcohol; and then has a gloss layer.

2. The ink-jet recording sheet according to claim 1, wherein 75 degree C. specular gloss (JIS P8142) is 40% or more.

3. The ink-jet recording sheet according to claim 1, wherein the support is a gas impermeable support.

4. The ink-jet recording sheet according to claim 3, wherein 75 degree C. specular gloss (JIS P8142) of the gas impermeable support is 60% or more.

5. The ink-jet recording sheet according to claim 1, wherein the fine particle silica is secondary particles having the average particle size of 8 nm to 500 nm which are formed by aggregation of primary particles having the average particle size of 3 nm to 100 nm.

6. The ink-jet recording sheet according to claim 1, wherein specific surface area and pore volume of the fine particle silica measured with nitrogen adsorption method meet the following formula 1.
Specific surface area (m²/g)<730−600×Pore volume (ml/g) (Formula 1)

7. The ink-jet recording sheet according to claim 6, wherein the specific surface area and the pore volume of the fine particle silica measured with nitrogen adsorption method meet the following formula 2.
Specific surface area (m²/g)>450−600×Pore volume (ml/g) (Formula 2)

8. The ink-jet recording sheet according to claim 7, wherein the specific surface area of the fine particle silica is 150 to 300 m²/g and the pore volume thereof is 0.5 to 0.9 ml/g.

9. The ink-jet recording sheet according to claim 1, wherein the fine particle silica is produced by the polycondensation of active silicic acid.

10. The ink-jet recording sheet according to claim 1, wherein the electrolytes are at least one kind of compounds selected from the group consisting of alkaline metal salts and alkaline earth metal salts.

11. The ink-jet recording sheet according to claim 10, wherein the electrolytes are salts of strong acids of alkaline metals.

12. The ink-jet recording sheet according to claim 1, wherein the ratio of the electrolyte content is 0.05 to 5 parts by weight relative to 100 parts of the fine particle pigments.

13. The ink-jet recording sheet according to claim 1, wherein the degree of saponification of polyvinyl alcohol is 90% or more.

14. The ink-jet recording sheet according to claim 1, wherein the degree of polymerization of polyvinyl alcohol is 1700 or more.

15. The ink-jet recording sheet according to claim 1, wherein the porous ink absorbing layer has two peaks or one wide peak having shoulders in the range of the pore diameter of 6 nm to 150 nm in the pore distribution curve measured by a mercury porosimetry.

16. The ink-jet recording sheet according to claim 15, wherein an absolute value of difference between a mode pore diameter and median pore diameter in the pore distribution curve is 10 nm or more.

17. The ink-jet recording sheet according to claim 15, wherein the pore volume of the porous ink absorbing layer in the range of pore diameter from 6 nm to 1 μm is 0.5 to 2.0 ml/g.

18. The ink-jet recording sheet according to claim 1, wherein surface pH of the porous ink absorbing layer is 5 to 10.

19. The ink-jet recording sheet according to claim 1, comprising the steps of coating a support with a water-based coating liquid(s) of pH 7 or more containing the fine particle silica, the electrolytes and polyvinyl alcohol; and then drying it to form the porous ink absorbing layer.
